(19) United States
(12) Patent Application Publication
(10) Pub. No.: US 2011/0213715 A1
(43) Pub. Date: Sep. 1, 2011

(54) Lean Analytics

(75) Inventors: Mark O. George, Dallas, TX (US); John Henry Smith, Bedford, TX (US)

(73) Assignee: Accenture Global Services GmbH, Schaffhausen (CH)

(21) Appl. No.: 12/714,892

(22) Filed: Mar. 1, 2010

(51) Int. Cl. G06Q 10/00; G06Q 50/00

(52) U.S. Cl. 705/301; 705/348

(57) ABSTRACT

Methods, systems, and apparatus, including computer programs encoded on a computer storage medium, for improving business processes. In one aspect, a method includes defining, for a workstation, a metric that is a function of multiple process variables, providing, to a Lean practitioner candidate, information that suffices to allow the Lean practitioner candidate to determine outcomes of independently applying a same, pre-defined amount of Lean Six Sigma-related change to each of two or more of the process variables, and obtaining information that specifies the outcomes from the Lean practitioner candidate.

### TECHNICAL FIELD

The present disclosure generally relates to Lean Six Sigma methodology.

### BACKGROUND

Many different business management strategies have been developed to monitor and benchmark improvements to business processes, such as processes relating to manufacturing, design, accounting, or other fields. One well-known business management strategy is Kaizen, a Japanese term related to improvement. The Kaizen philosophy pursues continuous improvement in manufacturing or other business activities. These improvements, in a general sense, can involve identifying and streamlining discrete business processes, thereby reducing or eliminating waste and inefficiency in a business.

An example of the Kaizen philosophy applied to a business model is Lean Production, a model that can be described as a bottom line centric effort to generate a greater value through allocating fewer resources (e.g., time, materials, etc.). Lean Production is strongly aligned with eliminating wastefulness in a process. A variation on Lean Production is Lean Manufacturing which focuses on removing inefficiencies by optimizing work flow.

The four goals of Lean Manufacturing are as follows: to improve quality, eliminate waste, to reduce process duration (e.g., decrease process cycle time), and to reduce total costs. In waste elimination, seven main areas are targeted: the unnecessary transportation of materials, excess inventory, efficiency in process layout, periods of inactivity, over production, extra processing (e.g., reworking or reprocessing), and errors or defects.

The Six Sigma business management strategy includes a set of practices designed to improve a process and eliminate errors or defects generated by the process. The Six Sigma business management strategy focuses on quality management, using a defined sequence of steps and quantifiable targets, such as cost reduction, turnover rate, or safety, to measure success.

A variation on the Six Sigma business management strategy, referred to as Lean Six Sigma, combines Six Sigma concepts with Lean Manufacturing concepts. While Six Sigma may tend to focus upon obtaining maximum quality output without a concern for speed or expense, Lean Production may aid in speeding a process along without concern for removing waste (e.g., errors, discarded product, etc.) and improving overall quality. Through the combination of the two business strategies, Lean Six Sigma aims to optimize overall value in the targeted process.

In a manufacturing setting, business process optimization strategies can be applied at different stages of a process. For example, a process can include a setup stage, a production stage, and a cleanup stage. Additionally, business process strategies can be applied to different process outcome variables, such as the quantity or percentage of product discard, the error frequency, or the quantity of post-process scrap. Prioritization of the application of business process strategies towards targeted improvements (e.g., shortening the duration of one of the process stages, error reduction, or scrap reduction) can often be arbitrary.

### SUMMARY

In general, one innovative aspect of the subject matter described in this specification may be embodied in processes that include the actions of defining, for a workstation, a metric that is a function of multiple process variables, providing, to a Lean practitioner candidate, information that suffices to allow the Lean practitioner candidate to determine outcomes of independently applying a same, predefined amount of Lean Six Sigma-related change to each of two or more of the process variables, and obtaining information that specifies the outcomes from the Lean practitioner candidate. Other embodiments of this aspect include corresponding systems, apparatus, and computer programs, configured to perform the actions of the methods, encoded on computer storage devices.

These and other embodiments may each optionally include one or more of the following features. For instance, the metric may be a workstation turnover time metric that measures an amount of time that is required to set up and run one batch of product through the workstation; the actions may also include determining, from the obtained information, that applying the predefined amount to a first process variable results in a linear outcome or in a non-linear outcome; providing information that suffices to allow the Lean practitioner candidate to determine the outcomes of independently applying the same, predefined amount of Lean Six Sigma-related change to each of two or more of the process variables may further include providing the metric to the Lean practitioner candidate, and instructing the Lean practitioner candidate to determine, as a baseline outcome, a value for the metric using a first baseline value for a first process variable and a second baseline value for a second process variable, to determine an improved first process variable value based on applying the predefined amount of change to the first baseline value, to determine an improved second process variable value based on applying the predefined amount of change to the second baseline value, to determine, as a first possible outcome, a value for the metric using the improved first process variable value for the first process variable and the second baseline value for the second process variable, and to determine, as a second possible outcome, a value for the metric using the first baseline value for the first process variable and the improved second process variable value for the second process variable; the actions may further include selecting, from among the two or more of the process variables, a process variable that exhibits a most improved outcome based on the application of the same, predefined amount of Lean Six Sigma-related change to each of the two or more process variables; each outcome may be expressed as an improvement over a baseline value; the predefined amount of Lean Six Sigma-related change may be expressed as a percentage improvement over a baseline value of each respective process variable; the actions may include using the outcomes to prioritize implementation of the Lean Six Sigma-related change for the two or more of the process variables; the provided information may further include the metric, a target production rate, and an instruction to determine an outcome of independently applying a same, predefined percentage of Lean Six Sigma-related change to first through fourth process variables, and the first process variable may represent a set up duration, the second process variable may represent an up-time duration, a third process variable may represent an amount of scrap, and a fourth process variable may represent a cleanup duration; the actions may also include selecting, from among the two or more of the process variables, the process variables that exhibit non-linear outcomes based on the application of the same, predefined amount of Lean Six Sigma-related change to each of the two or more process variables; and/or the actions may include facilitating training for the Lean practitioner candidate to implement Lean Six Sigma change on the selected process variables.

In general, another innovative aspect of the subject matter described in this specification may be embodied in processes that include the actions of receiving information from a project manager, the information specifying predefined amount of Lean Six Sigma-related change, and a metric for workstation, where the metric is a function of multiple process variables, determining, using the information, outcomes of independently applying the same, predefined amount to each of two or more of the process variables, and providing information that specifies the outcomes to the project manager. Other embodiments of this aspect include corresponding systems, apparatus, and computer programs, configured to perform the actions of the methods, encoded on computer storage devices.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

Referring now to the drawings, in which like reference numbers represent corresponding parts throughout:

FIG. 1 is a conceptual diagram of a system for anticipating the outcomes of independently applying a pre-defined amount of Lean Six Sigma-related change to two or more process variables;

FIG. 2A is a timeline illustrating an example total workstation turnover time for a Lean Six Sigma methodology candidate process;

FIG. 2B illustrates an example approach used to describe the outcome of the process illustrated in FIG. 2A;

FIG. 3A is a modified timeline illustrating the candidate process of FIG. 2A after the application of a Lean Six Sigma change involving a reduction in setup time;

FIG. 3B illustrates the setup of an example approach used to describe the outcome of the process illustrated in FIG. 3A;

FIG. 3C illustrates the solution of the example approach illustrated within FIG. 3B to determine a percentage improvement achievable through applying a reduction in setup time;

FIG. 4A is a modified timeline illustrating the candidate process of FIG. 2A after the application of a Lean Six Sigma change involving an increase in up-time;

FIG. 4B illustrates the setup of an example approach used to describe the outcome of the process illustrated in FIG. 4A;

FIG. 4C illustrates the solution of the example approach illustrated within FIG. 4B to determine a percentage improvement achievable through applying an increase in up-time;

FIG. 5A is a modified timeline illustrating the candidate process of FIG. 2A after the application of a Lean Six Sigma change involving a reduction in scrap;

FIG. 5B illustrates the setup of an example approach used to describe the outcome of the process illustrated in FIG. 5A;

FIG. 5C illustrates the solution of the example approach illustrated within FIG. 5B to determine a percentage improvement achievable through applying a reduction in scrap;

FIG. 6 illustrates the solution of the example approach illustrated within FIG. 5B to determine a percentage improvement achievable through applying an elimination of scrap.

### DETAILED DESCRIPTION

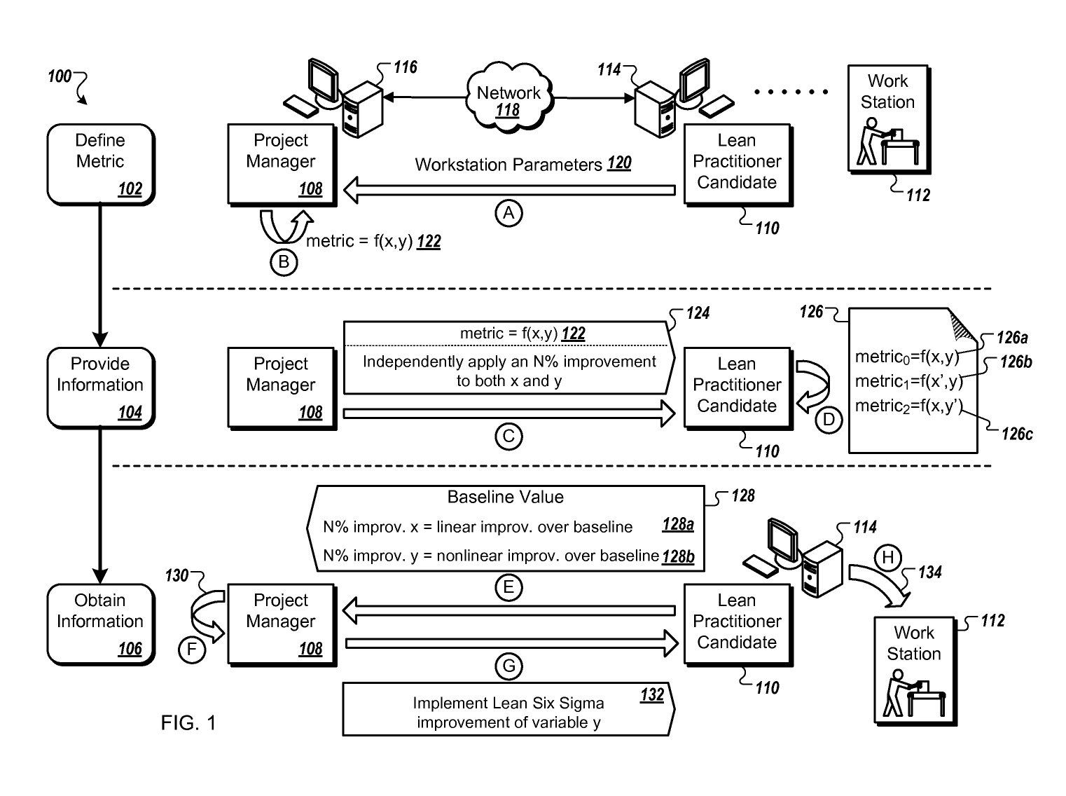

FIG. 1 is a conceptual diagram of a system 100 for anticipating the outcomes of independently applying a pre-defined amount of Lean Six Sigma-related change to two or more process variables. In the system, three operations 102, 104, and 106 are illustrated, each operation involving communication between a project manager 108 (or a computing device 116 associated with the project manager 108) and a Lean practitioner candidate 110 (or a computing device 114 associated with the Lean practitioner candidate 110). During a first operation 102, performance information regarding a process executed by one or more work stations 112 can be modeled as an equation describing a process metric in terms of two or more process variables. The two or more process variables are independently modified at a second operation 104 to determine relative impact upon the metric. The metric impact can then be evaluated, at a third operation 106, and a selected process variable improvement applied as a Lean Six implementation upon the work station(s) 112.

The work station(s) 112 can include one or more manufacturing or industrial processes operating in concert as a discrete work flow including, but not limited to, material production, material processing, part production, product assembly, or product packaging. The work flow performed by the work station(s) 112 can be described as a series of stages, each stage involving a duration of time. These stages, in some examples, can include a set up duration (e.g., loading material, inserting specialized tools, programming automation functionality, running a test analysis of the work station(s) 112, etc.), an up-time duration (e.g., run time or production time), a changeover duration (e.g., switch one or more specialized tools or materials to achieve a variation of product), or a shutdown duration (e.g., cleaning up the work station(s) 112, disposing of any post-process discard product or materials). The outcome of the work flow can involve a metric or measurement, such as a quantity of product, a number of parts or assembled units, or a length, volume, or weight of material produced. The quantity of product, in some circumstances, can include both a usable quantity of product and a discard quantity of product. For example, during the production of assembled units, one or more of the units may include errors or defects that make those units unusable or inadequate for sale.

The Lean practitioner candidate 110 can measure or track the duration of each stage of the work flow, the quantity of product, and the discard quantity of product as workstation parameters associated with the work station(s) 112. The Lean practitioner candidate 110 may include one or more process management or quality assurance personnel or groups trained in analyzing the efficiency and productivity of the work station(s) 112. The training can include Six Sigma, Lean Production, Lean Six Sigma, Kaizen, or similar training which provides the Lean practitioner candidate 110 with knowledge needed to analyze the various work station production stages and production variables to recognize potential areas for improvement. In some examples, the Lean practitioner candidate 110 can oversee a production line, processing facility, tool shop, assembly line, packaging line, factory, or other production unit including one or more discrete processes which may be candidates for Lean Six Sigma improvements. The Lean practitioner candidate 110 can access a candidate computing device 114 or network of computing devices which include automatically measured workstation parameters and/or technician-inputted workstation parameters. The Lean practitioner candidate 110 can provide a set of workstation parameters 120 to the project manager 108.

In some implementations, in addition to workstation parameters 120, the Lean practitioner candidate 110 can designate one or more business-driven goals, such as a target production rate, in the set of workstation parameters 120.

The Lean practitioner candidate 110, in some implementations, may further provide an analysis of potential areas for improvement to the project manager 108. For example, based upon Lean Manufacturing principles of improved cycle duration or waste elimination, the Lean practitioner candidate 110 can target areas for improvement, optionally including an estimate of the cost or effort involved in implementing the improvement. When conducting the analysis, the Lean practitioner candidate 110 may create a Value Stream Map of the process executed using the work station(s) 112 to better understand the current conditions in the process. The Lean practitioner candidate may collect data related to the process executed using the work station(s) 112 to understand the voice of the process (VOP). VOP can be used to understand the significance of individual measurements by plotting time-sequenced events and individual results on a control chart. The control chart can aid in identifying potential Lean Six Sigma improvements. Once measurements have been taken and statistical data collected, in some implementations, the Lean practitioner candidate 110 can brainstorm with the team (e.g., technicians working at the work station(s) 112, local quality assurance team members, Lean Six Sigma-trained peers, or the project manager 108, etc.) to identify potential Lean Six Sigma-related improvements.

In some implementations, the workstation parameters 120 can be transmitted between the candidate computing device 114 and a project manager computing device 116, for example through a network 118. Alternatively, the workstation parameters 120 could be copied to a computer-readable storage medium by the Lean practitioner candidate 110, and the computer-readable storage medium could be delivered to the project manager 108.

The project manager 108, for example, can include an internal business management practitioner or an external Lean Six Sigma consultant, tasked with helping to prioritize Lean Six Sigma improvement areas under the jurisdiction of the Lean practitioner candidate 110. The project manager computing device 116 can be used to analyze the workstation parameters 120 and arrange a subset of the workstation parameters 120 to define a metric 122 modeled as a function of two or more process variables, the process variables each based upon either a single one of the workstation parameters 120 or a combination thereof. In one example, the metric 122 may be a workstation turnover time equated to the sum of the durations of all of the stages of production at the workstation(s) 112. In another example, the metric 122 may be a batch size metric equated to the total product less the scrap (e.g., discarded product) produced during the workstation turnover time of the workstation(s) 112.

After the metric 122 has been defined at the first operation 102, the system 100 enters the second operation 104 where metric and goal information 124 is provided back to the Lean practitioner candidate 110. As shown in FIG. 1, the project manager 108 provides the metric 122 along with a goal of an integer percentage (e.g., N %) improvement to the Lean practitioner candidate 110 in the metric and goal information 124. The integer percentage improvement, for example, can refer to independently applying a percentage improvement to two different workstation parameters or combinations of workstation parameters. These workstation parameters, for example, can include a first parameter x regarding the product yield of the process performed at the workstation(s) 112 and a second parameter y regarding the cleanup duration of the process performed at the workstation(s) 112. The percentage improvement, in some examples, can include a positive integer improvement such as five, ten, or fifteen percent.

The Lean practitioner candidate 110 receives the metric and goal information 124 (e.g., at the candidate computing device 114 from the project manager computing device 116) and calculates a set of comparison metrics 126. First, the Lean practitioner candidate calculates a baseline metric₀ 126a using the current values for both workstation parameter x and workstation parameter y. The Lean practitioner candidate 110 then applies the percentage improvement to the first workstation parameter x while holding the baseline parameter y to calculate an x-modified metric₁ 126b and, similarly, applies the percentage improvement to parameter y while holding the baseline parameter x to calculate a y-modified metric₂ 126c. These calculations, for example, can be performed upon the candidate computing device 114 or another computing device, or these calculations can be performed manually by the Lean practitioner candidate 110. In some implementations, the Lean practitioner candidate can use a Lean Six Sigma software application to determine the set of comparison metrics 126.

In some implementations, the Lean practitioner candidate 110 borrows information from previous analysis of potential areas for improvement to aid in calculating the comparison metrics 126. For example, an analysis of the individual contributors to the duration of a phase of the production process can aid the Lean practitioner candidate 110 in determining the relative effect a shortening of the duration of this phase could have upon the greater process.

The Lean practitioner candidate 110 can further compare the baseline metric₀ 126a to the x-modified metric₁ 126b to determine an x-modified percentage improvement over baseline 128a. Similarly, the baseline metric₀ 126a can be compared to the y-modified metric₂ 126c to determine a y-modified percentage improvement over baseline 128b. The Lean practitioner candidate 110 can provide the set of baseline comparison values 128 to the project manager 108 at the third operation 106 of the system 100. The project manager obtains the baseline comparison values 128 (e.g., at the project manager computing device 116).

The project manager 108 can evaluate 130 the baseline values 128 to prioritize the proposed Lean Six Sigma improvements based upon relative impact to the overall metric 122 over the baseline metric₀ 126a. For example, the x-modified percentage improvement over baseline 128a shows a linear (e.g., N %) improvement over the baseline metric₀ 126a, while the y-modified percentage improvement over baseline 128b shows a non-linear (e.g., (N+M) %) improvement over the baseline metric₀ 126a. Thus, the project manager 108 can choose to implement the Lean Six Sigma improvement of workstation parameter y because of the greater impact to the metric 122. If, instead, both baseline comparison values 128 indicated non-linear improvement, the project manager 108 could rank the baseline comparison values 128 by the relative impact of each of the baseline comparison values 128. In addition to percentage improvements, in some implementations, the project manager 108 can consider variables such as time to implement, cost to implement, or applicability of implementation across other similar work station environments (not illustrated) when selecting a Lean Six Sigma improvement to implement.

The project manager 108 can trigger 132 the implementation of the Lean Six Sigma improvement of variable y by the Lean practitioner candidate 110, for example through communicating the decision to the Lean practitioner candidate 110. The Lean practitioner candidate 110 can execute 134 the implementation at the work station(s) 112. In some implementations, execution of the Lean Six Sigma improvement at the work station(s) 112 can involve one or more pilot or test runs prior to introducing a full implementation.

Once the process has been updated to reflect the Lean Six Sigma improvement, in some implementations, the Lean practitioner candidate can document the new process improvements and sustain the realized gains by collecting measurements and periodically recalculating the metric 122 to verify that the process continues to reflect the Lean Six Sigma improvement anticipated by the y-modified metric₂ 126c.

The project manager 108, in some implementations, can facilitate training for the Lean practitioner candidate 110 to implement the Lean Six Sigma improvement on the selected process variable y. For example, the project manager 108 can aide in providing training towards the application of one or more Lean Six Sigma tools such as Kanban (visual signaling system) or poka-yoke (mistake avoidance).

One or more of the operations 102, 104, and 106 of the system 100 can be implemented in a different order or employing fewer or more computing devices. For example, although the project manager 108 and the Lean practitioner candidate 110 are illustrated as two individual systems separated by the network 118, in some implementations the operations 102, 104, and 106 of the system 100 can be implemented upon a single computer system. In another example, during operation 104, the project manager 108 can provide the metric and goal information 124 to the Lean practitioner candidate 110 for validation and acceptance, thereafter generating the set of comparison metrics 126 upon the project manager computing device 116. Also, the evaluation 130 of the baseline values 128 and prioritization of the proposed Lean Six Sigma improvements, in some implementations, can occur as a collaboration between the project manager 108 and the Lean practitioner candidate 110.

The operations 102, 104, and 106 of the system 100, in some implementations, may be repeated, after implementation 134 of the Lean Six Sigma improvement of variable y at the work station(s) 112, to evaluate further Lean Six Sigma improvements related to the process occurring upon the work station(s) 112.

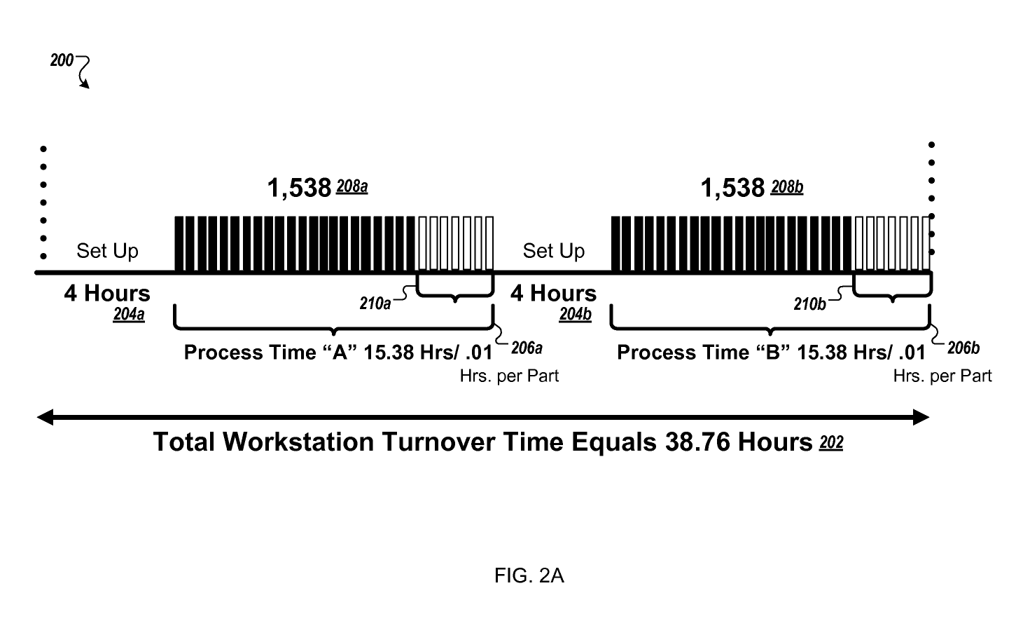

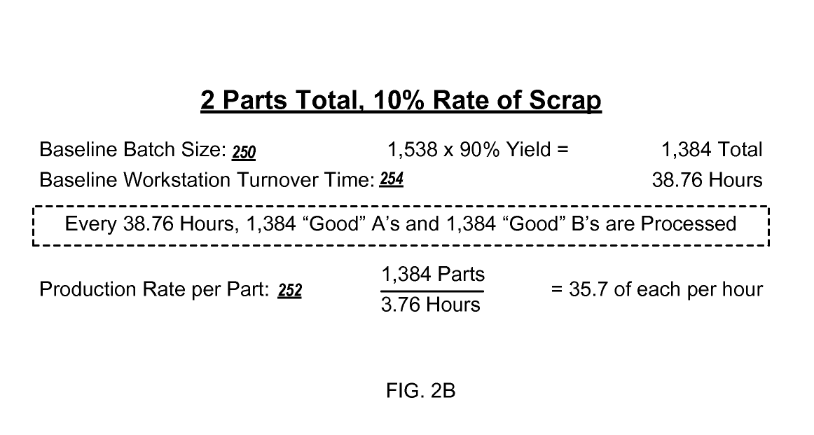

FIGS. 2 to 6 illustrate one non-limiting example of the optimization of a business process using the process 100. Specifically, FIG. 2A is a timeline 200 illustrating an example total workstation turnover time 202 for a Lean Six Sigma methodology candidate process. The information presented by the timeline 200, for example, can be used to define a metric used for comparing candidate Lean Six Sigma improvements to a baseline value. The timeline includes a set of two setup phases 204, each having a duration of four hours, and a set of two production phases 206, each having a duration of 15.38 hours, combining to produce the total workplace turnover time of 38.76 hours. During each of the production phases 206, a batch size 208 of 1,538 parts are processed (e.g., produced, assembled, cleaned, painted, dried, tested, etc.). During each of the production phases 206, a percentage of scrap parts 210 are also processed.

In some implementations, the process illustrated in the timeline 200 describes an operation which processes two different types of parts or two variations of a same part, each type of part having a same setup duration and a same processing duration to generate a same number of parts and a same number of scrap parts. By dividing the number of parts per batch (e.g., 1,538) by the processing duration of 15.38 hours, it is determined that parts are processed at a hundredth of an hour per part.

As shown in FIG. 2B, the information derived from the timeline 200 of FIG. 2A is used to construct an example approach or model describing the outcome of the process illustrated in FIG. 2A in terms of equations. This approach can define a baseline metric related to the process. The process includes processing two separate types of parts, with a ten percent rate of scrap (e.g., error or discarded) parts for each of the two types.

The two types of parts can be described as being processed in batches, the total batch being adjusted by the yield of non-scrap parts processed during the process duration. For example, a baseline batch size 250 of 1,384 can be derived by multiplying the total number of parts processed by the yield (e.g., non-scrap) output. The baseline workstation turnover time 254 is 38.76 hours, as illustrated by the timeline 200 of FIG. 2A. Based upon this information, every 38.76 hours, 1,384 non-scrap parts from the first batch 208a and 1,384 non-scrap parts from the second batch 208b are processed. By dividing the baseline batch size 250 by the baseline workstation turnover time, a baseline production rate per part 252 of 35.7 of each type of part per hour can be determined.

In some implementations, the baseline workstation turnover time 254 or the baseline batch size 250 can be used as a baseline metric when determining which Lean Six Sigma improvement to implement. The production rate per part 252, for example, can be held as a target value when defining adjustments to one of the metrics in an effort to improve efficiency while holding the production rate per part to at least 35.7 parts of the first type and 35.7 parts of the second type within each hour. For example, the goal of analyzing various Lean Six Sigma improvements against the baseline workstation turnover time 254 or the baseline batch size 250 can be to determine the improvement that is likely to generate the greatest positive impact on work in progress and workstation turnover time. For example, relative benefits can be compared in considering incremental or continuous improvements relating to non-linear improvement relationships. Often, non-linear improvement relationships can be non-intuitive to the Lean practitioner candidate. In evaluating the effect of a number of circumstances, the Lean practitioner candidate can evolve a better understanding of the most beneficial Lean Six Sigma improvement(s).

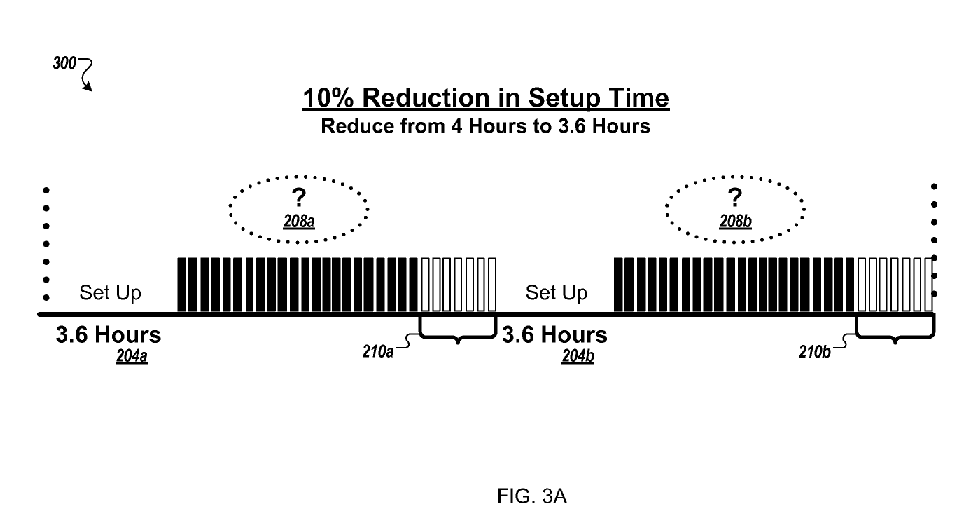

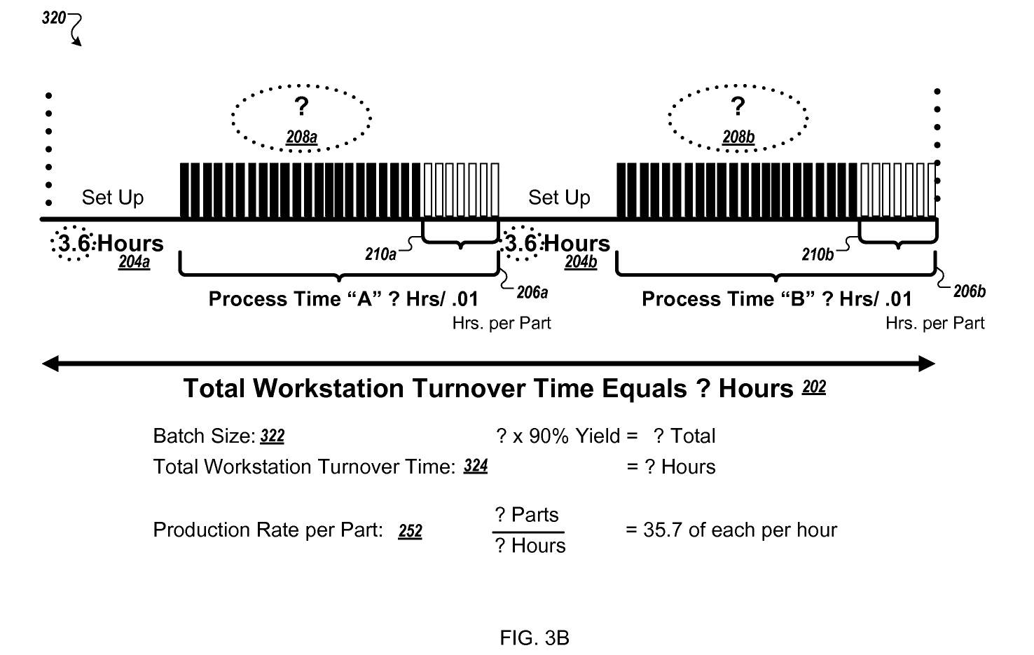

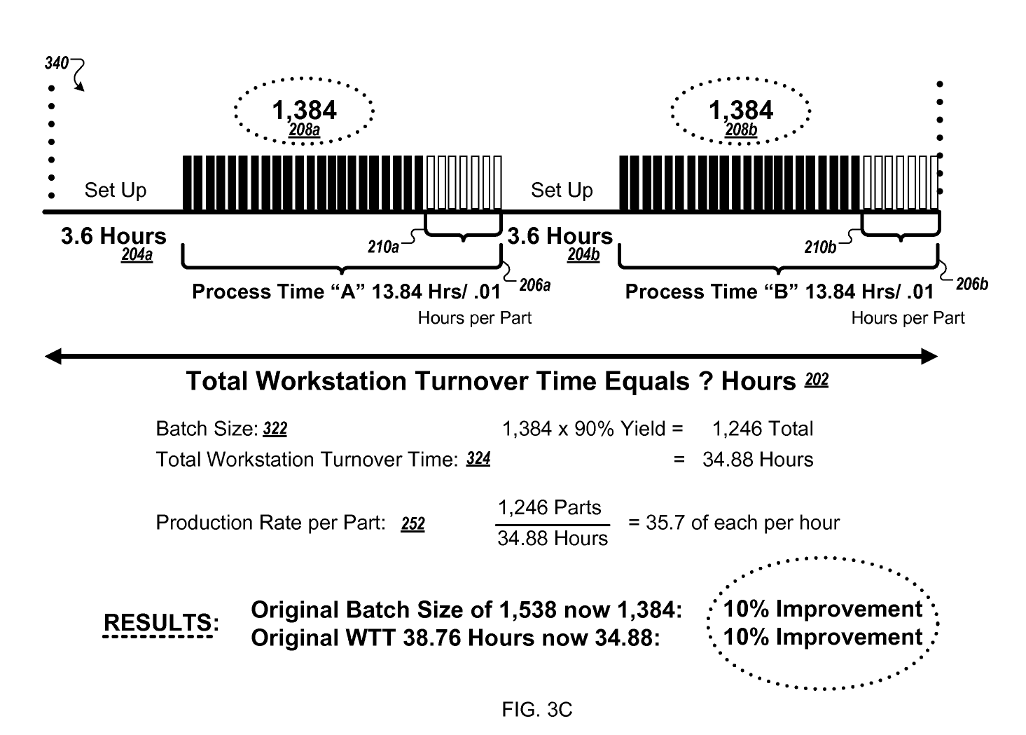

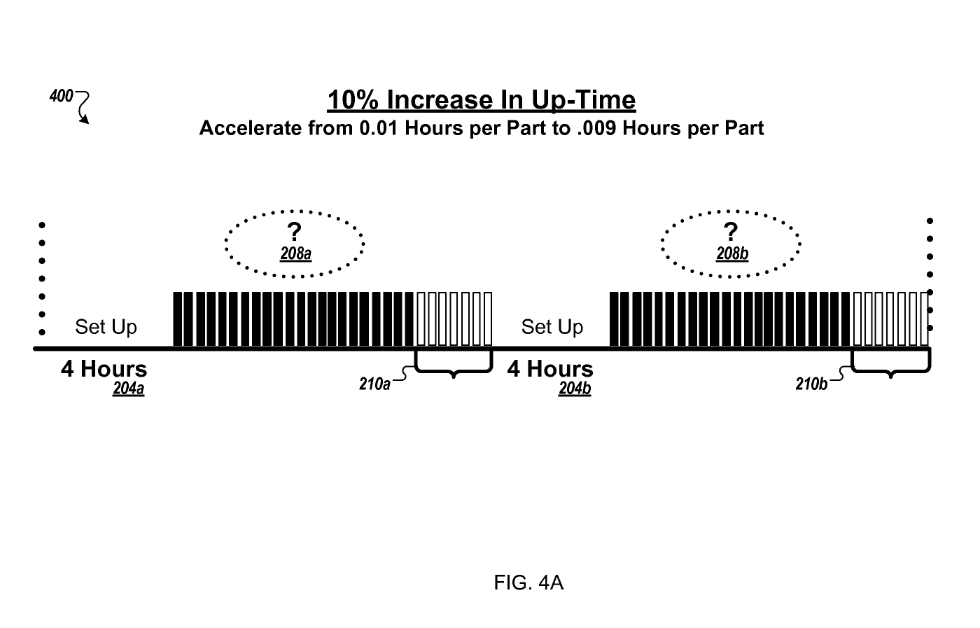

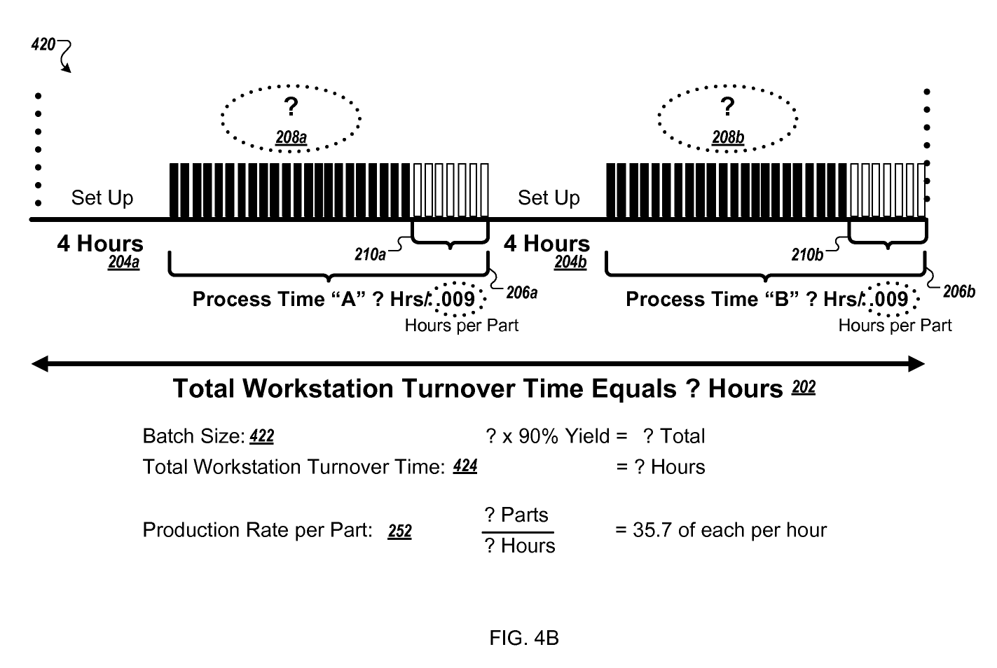

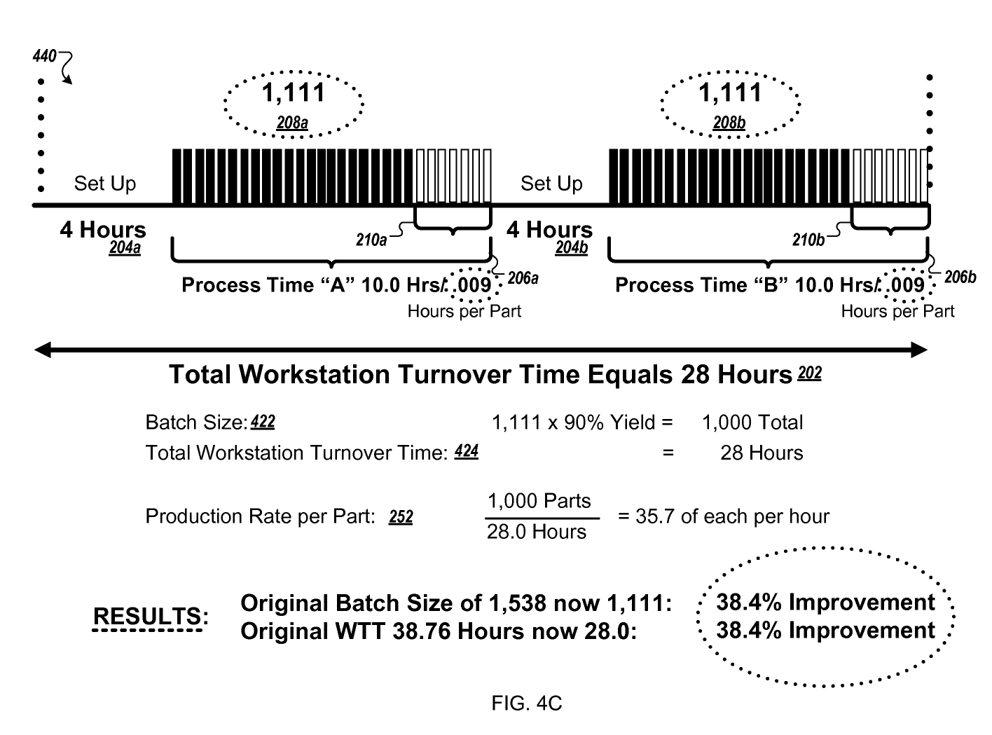

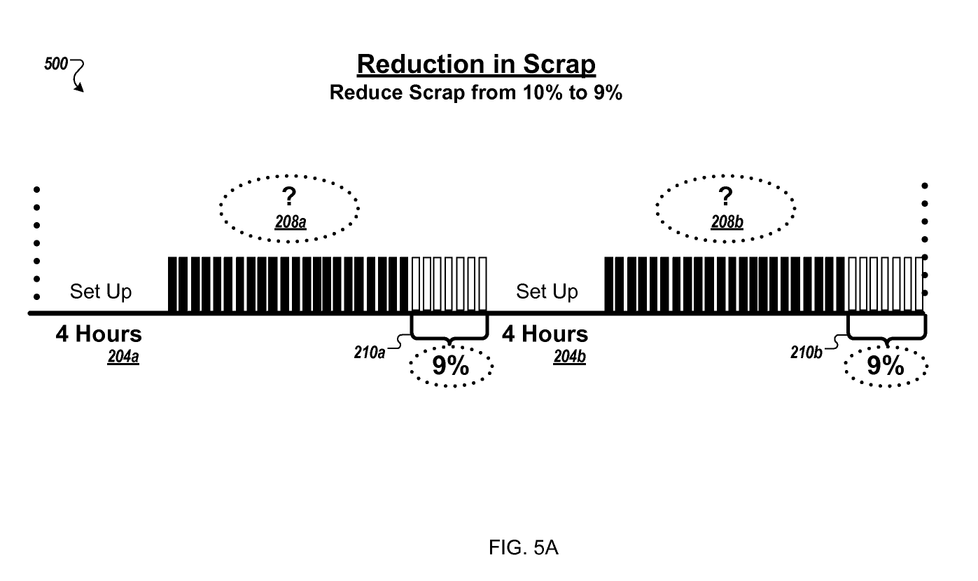

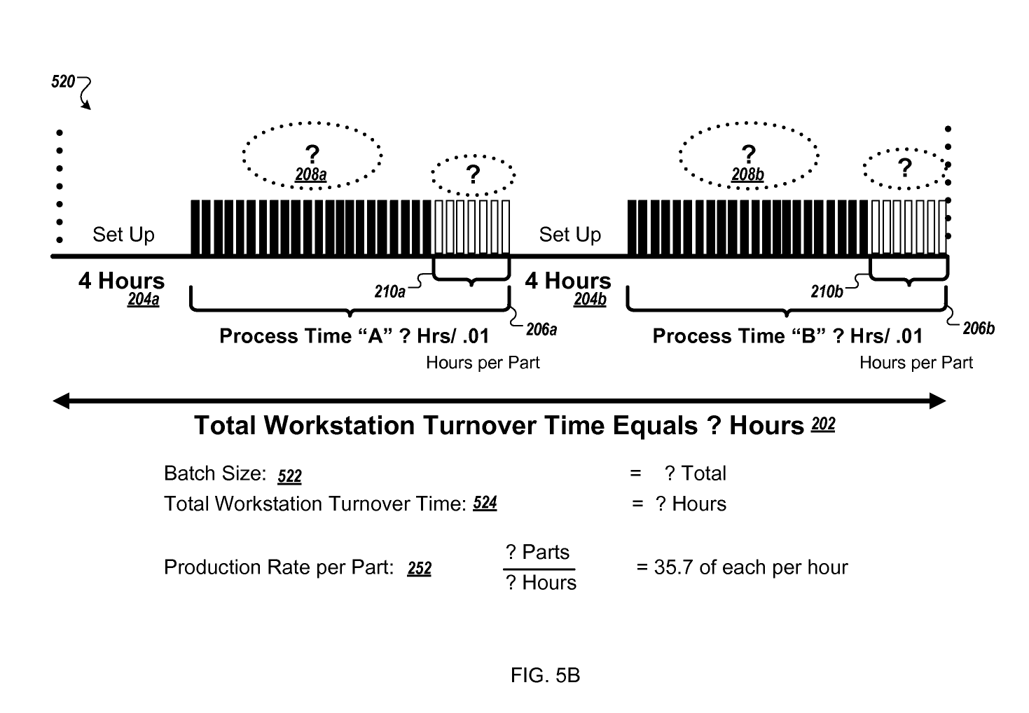

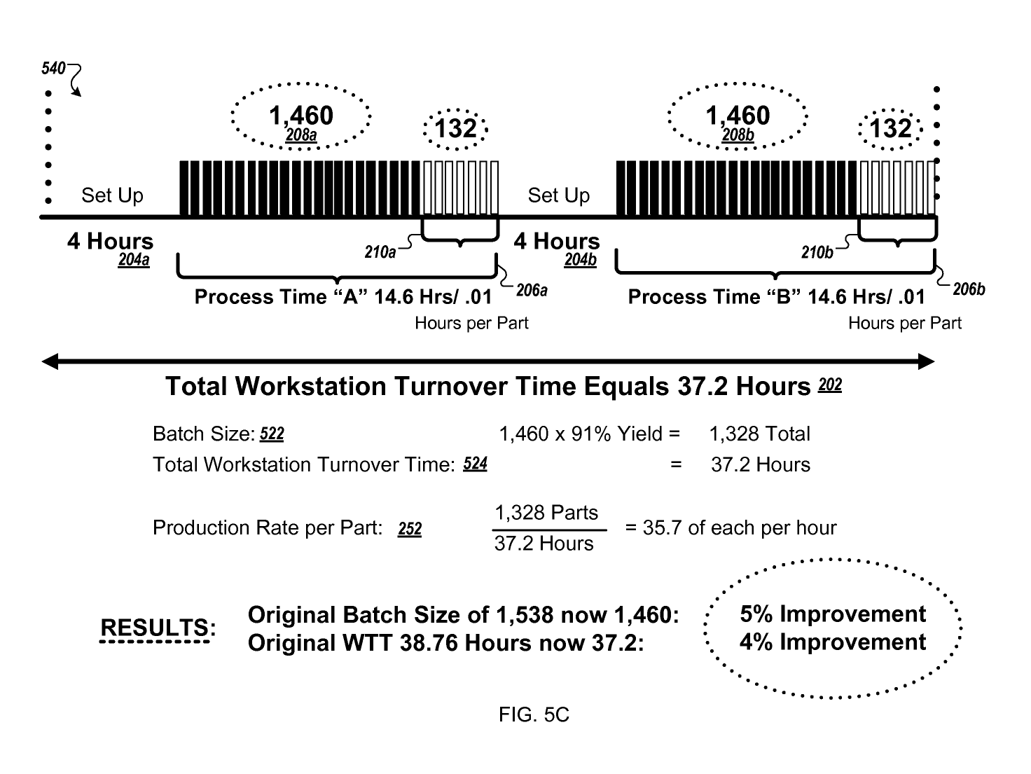

Three example project proposals, each evaluated by independently applying a same, predefined amount of Lean Six Sigma-related change, are detailed as follows. FIGS. 3A through 3C illustrate a setup time reduction improvement. FIGS. 4A through 4C illustrate a processing rate increase improvement. FIGS. 5A through 5C illustrate a scrap part reduction improvement. Upon analyzing the improvements illustrated in the figures listed above, each project can be prioritized based upon impact, and an implementation decision can be made.

FIG. 3A is a modified timeline 300 illustrating the candidate process of FIG. 2A after the application of a Lean Six Sigma change involving a reduction in setup time. As shown in the timeline 300, the setup duration 204 has been reduced by ten percent, shortening the setup duration 204 from 4 hours to 3.6 hours. The percentage of scrap parts 210 remains at ten percent, while the actual number of scrap parts may be unknown in the hypothetical circumstance illustrated in the timeline 300, because the total number of parts 208 will be recalculated based upon the adjusted setup duration 204.

FIG. 3B illustrates the setup of an example approach 320 used to describe the outcome of the process illustrated in FIG. 3A. The process duration 206 is unknown. A reduced setup duration batch size 322 and a reduced setup duration workstation turnover time 324 can be calculated based, in part, upon the setup duration 204a of 3.6 hours and the production rate per part 252 of 35.7.

The approach of achieving the setup duration reduction, in some implementations, can be based upon an analysis of the components included within the setup duration. In some examples, these components can include both linear (e.g., time to load each of a number of parts to be processed) as well as non-linear (e.g., switching tools or dies in the workstation) events. For example, the Lean practitioner candidate 110 (as described in relation to FIG. 1) can evaluate the various linear and non-linear operations involved in the setup stage to determine a real life impact of a reduction in setup duration upon the amount of product being processed.

FIG. 3C illustrates a solution 340 of the example approach illustrated within FIG. 3B to determine a percentage improvement achievable through applying a reduction in setup time. A linear relationship between setup duration and process duration is discovered through this example.

Based upon the linear reduction in batch size, a reduced setup duration batch size 322 can be calculated as 1,246 by applying a ninety percent yield (e.g., ten percent scrap) adjustment to a batch size linearly adjusted to be ten percent smaller than baseline (e.g., 1,384 total processed parts) due to the reduced setup duration. Applying the reduced setup duration batch size 322 to the equation of production rate per part 252, a reduced setup duration workstation turnover time 324 of 34.88 hours can be determined.

In comparing the reduced setup duration batch size 322 of 1,384 to the to the baseline batch size 250 of 1,538, a ten percent improvement can be calculated. Similarly, in comparing the reduced setup duration workstation turnover time 324 of 34.88 hours to the baseline workstation turnover time 254 of 38.76 hours, a ten percent improvement can be calculated. Thus, a ten percent reduction of setup time equates to a ten percent (linear) improvement of both batch size and workstation turnover time.

FIG. 4A is a modified timeline 400 illustrating the candidate process of FIG. 2A after the application of a Lean Six Sigma change involving an increase in up-time duration productivity. As shown in the timeline 400, the setup duration 204 has been returned to the baseline value of four hours. The percentage of scrap parts 210 remains at ten percent, while the actual number of scrap parts may be unknown in the hypothetical circumstance illustrated in the timeline 400, because the total number of parts 208 will be recalculated based upon the processing acceleration from 0.01 hours per part to 0.009 hours per part.

FIG. 4B illustrates the setup of an example approach 420 used to describe the outcome of the process illustrated in FIG. 4A. The process duration 206 is unknown. An increased up-time productivity batch size 422 and an increased up-time productivity workstation turnover time 424 can be calculated based, in part, upon the processing time of 0.009 hours per part and the production rate per part 252 of 35.7.

The framework for achieving the increased up-time productivity, in some implementations, can be based upon an analysis of the components included in the duration of the production phases 206. In some examples, these components can include process layout (e.g., improving efficiency), process bottlenecks (e.g., opportunities for automation or additional labor), or equipment shortfalls (e.g., opportunities for work station equipment improvements). For example, the Lean practitioner candidate 110 (as described in relation to FIG. 1) can evaluate the components involved in the up-time stage of the process to determine a real life impact of a targeted up-time productivity increase upon the process duration 206 and the total number of parts 208. In some implementations, the processing rate per hour can be improved through total productive maintenance to reduce down time and repair time. For example, historical failures of the work station(s) 112, stored in the candidate computing device 114, can be analyzed to determine maintenance cycles which, when set in place, can avoid common failures. For example, greasing one or more parts on a set schedule, replacing consumable elements included in the equipment of the work station(s) 112 before performance problems occur, or sharpening blades before they become unreasonably dull can all contribute to a better functioning production cycle. These maintenance tasks can be performed, for example, at times when productivity less likely to be affected, such as non-peak or off-time hours.

FIG. 4C illustrates a solution 440 of the example approach illustrated within FIG. 4B to determine a percentage improvement achievable through applying an increase in up-time duration productivity. For example, total number of parts 208 of 1,111 and, optionally, the modified process duration 206 can be estimated by the Lean practitioner candidate 110 (shown in FIG. 1) based upon the modification proposed for decreasing the processing time to 0.009 hours per part. The increased up-time productivity batch size 422 can be calculated as 1,000 by applying a ninety percent yield (e.g., ten percent scrap) adjustment to the total number of parts 208 of 1,111. Applying the increased up-time productivity batch size 422 to the equation of production rate per part 252, the increased up-time productivity workstation turnover time 424 can be determined to total twenty-eight hours.

In comparing the increased up-time productivity batch size 422 of 1,111 to the to the baseline batch size 250 of 1,538, a 38.4 percent improvement can be calculated. Similarly, in comparing the increased up-time productivity workstation turnover time 424 of 28 hours to the baseline workstation turnover time 254 of 38.76 hours, a 38.4 percent improvement can be calculated. Thus, a ten percent increase in up-time productivity equates to a positive non-linear improvement of both batch size and workstation turnover time.

FIG. 5A is a modified timeline 500 illustrating the candidate process of FIG. 2A after the application of a Lean Six Sigma change involving a reduction in scrap. As shown in the timeline 500, the setup duration 204 is set to the baseline value of four hours. The percentage of scrap parts 210 has been adjusted to nine percent, while the actual number of scrap parts may be unknown in the hypothetical circumstance illustrated in the timeline 500, because the total number of parts 208 will be recalculated based upon the reduction in scrap from ten percent to nine percent.

FIG. 5B illustrates the setup of an example approach 520 used to describe the outcome of the process illustrated in FIG. 5A. The process duration 206 is unknown. A reduced scrap batch size 522 and a reduced scrap workstation turnover time 524 can be calculated based upon the nine percent adjusted scrap rate and the production rate per part 252 of 35.7.

The framework for achieving the reduction in scrap, for example, can be based upon statistical analysis of historical reasons for errors or defects within the parts produced by the process described in the timeline 200. In some examples, failures may be attributed to human error, equipment failure, or lack of precision in the timing or positioning of materials being processed. For example, human error may be alleviated by keying two or more parts being assembled so that they only fit together in a single manner, color-coding and simplifying operator instructions, or automating a problem point of the process. In another example, lack of processing equipment precision can be improved by adding fixturing. If equipment failure, such a dull blade, is found to be frequently at fault, productive maintenance may help in scrap reduction.

FIG. 5C illustrates a solution 540 of the example approach illustrated within FIG. 5B to determine a percentage improvement achievable through applying a reduction in scrap. For example, total number of parts 208 of 1,460 and, optionally, the modified process duration 206 of 14.6 hours can be estimated by the Lean practitioner candidate 110 (shown in FIG. 1) based upon the modification proposed for decreasing the amount of scrap by ten percent. A reduced scrap batch size 522 can be calculated as 1,328 by applying a ninety-one percent yield (e.g., nine percent scrap) adjustment to the total number of parts 208 of 1,460. Applying the reduced scrap batch size 522 to the equation of production rate per part 252, a reduced scrap workstation turnover time 524 can be determined to total 37.2 hours.

In comparing the reduced scrap batch size 522 of 1,460 to the to the baseline batch size 250 of 1,538, a 5 percent improvement can be calculated. Similarly, in comparing the reduced scrap workstation turnover time 524 of 37.2 hours to the baseline workstation turnover time 254 of 38.76 hours, a four percent improvement can be calculated. Thus, a ten percent reduction in generation of scrap parts equates to a negative non-linear improvement of both batch size and workstation turnover time.

In reviewing the example setup time reduction improvement project proposal shown in FIGS. 3A through 3C, the processing rate increase improvement project proposal shown in FIGS. 4A through 4C, and the scrap part reduction improvement project proposal shown in FIGS. 5A through 5C, the processing rate increase improvement project proposal of FIGS. 4A through 4C appears to be the most promising, with a non-linear positive improvement well above the predefined amount of Lean Six Sigma-related change of ten percent. For example, the project manager 108, upon reviewing the metrics provided within the processing rate increase improvement project proposal of FIGS. 4A through 4C, may choose to implement the processing rate increase improvement upon the work station(s) 112.

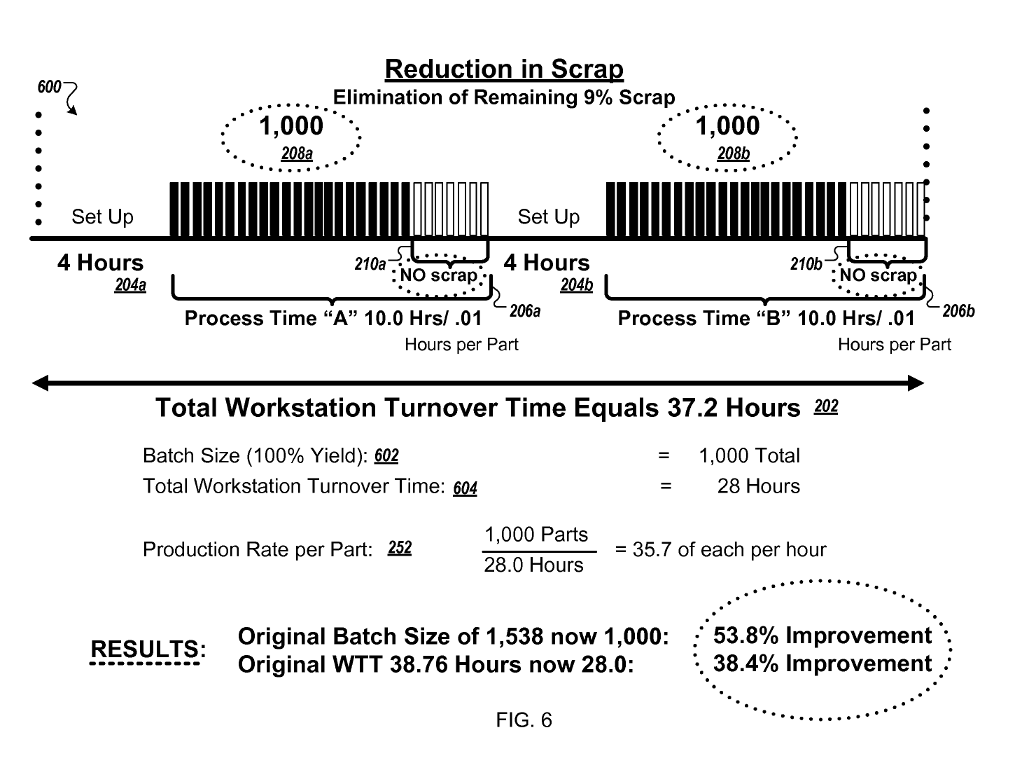

FIG. 6 illustrates the solution of the example approach illustrated within FIG. 5B to determine a percentage improvement achievable through applying an elimination of scrap. Although a total elimination of scrap may not be feasible, due to the relative expense of applying various Lean Six Sigma implementations towards scrap reduction, various improvements may be made which allow the process to approach scrap elimination. These various improvements, for example, may include Lean Six Sigma enhancements targeting each statistically relevant reason for errors in or discard of parts during the process described in the timeline 200, as identified by the Lean practitioner candidate 110.

As shown in FIG. 6, the total number of parts 208 of 1,000 and, optionally, the modified process duration 206 of ten hours can be estimated by the Lean practitioner candidate 110 (shown in FIG. 1). An eliminated scrap batch size 602 is equivalent to the total number of parts 208 of 1,000. Applying the eliminated scrap batch size 522 to the equation of production rate per part 252, an eliminated scrap workstation turnover time 604 can be determined to total 35.7 hours.

In comparing the eliminated scrap batch size 602 of 1,460 to the to the baseline batch size 250 of 1,538, a 53.8 percent improvement can be calculated. Similarly, in comparing the eliminated scrap workstation turnover time 604 of 37.2 hours to the baseline workstation turnover time 254 of 38.76 hours, a 38.4 percent improvement can be calculated. Thus, an elimination of the generation of scrap parts equates to a positive non-linear improvement of both batch size and workstation turnover time.

In some implementations, to realize the benefit of this positive non-linear improvement on both batch size and workstation turnover time, the project manager can iteratively target each statistically relevant cause of failure, beginning with the most prevalent. For example, the project manager 108 can instruct the Lean practitioner candidate to implement a series of Lean Six Sigma improvements, each Lean Six Sigma improvement tailored to repair a condition underlying a portion of the scrap part generation.

The features described may be implemented in digital electronic circuitry, or in computer hardware, firmware, software, or in combinations of them. The apparatus may be implemented in a computer program product tangibly embodied in an information carrier, e.g., in a machine-readable storage device for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A system comprising:
one or more computers; and
a computer-readable medium coupled to the one or more computers having instructions stored thereon which, when executed by the one or more computers, cause the one or more computers to perform operations comprising:
defining, for a workstation, a metric that is a function of multiple process variables,
providing, to a Lean practitioner candidate, information that suffices to allow the Lean practitioner candidate to determine outcomes of independently applying a same, predefined amount of Lean Six Sigma-related change to each of two or more of the process variables, and
obtaining information that specifies the outcomes from the Lean practitioner candidate.

2. The system of claim 1, wherein the metric comprises a workstation turnover time metric that measures an amount of time that is required to set up and run one batch of product through the workstation.

3. The system of claim 1, wherein the operations further comprise:
determining, from the obtained information, that applying the predefined amount to a first process variable results in a linear outcome.

4. The system of claim 1, wherein the operations further comprise:
determining, from the obtained information, that applying the predefined amount to a first process variable results in a non-linear outcome.

5. The system of claim 1, wherein providing information that suffices to allow the Lean practitioner candidate to determine the outcomes of independently applying the same, predefined amount of Lean Six Sigma-related change to each of two or more of the process variables further comprises:
providing the metric to the Lean practitioner candidate; and
instructing the Lean practitioner candidate to:
determine, as a baseline outcome, a value for the metric using a first baseline value for a first process variable and a second baseline value for a second process variable,
determine an improved first process variable value based on applying the predefined amount of change to the first baseline value,
determine an improved second process variable value based on applying the predefined amount of change to the second baseline value,
determine, as a first possible outcome, a value for the metric using the improved first process variable value for the first process variable and the second baseline value for the second process variable, and
determine, as a second possible outcome, a value for the metric using the first baseline value for the first process variable and the improved second process variable value for the second process variable.

6. The system of claim 1, wherein the operations further comprise:
selecting, from among the two or more of the process variables, a process variable that exhibits a most improved outcome based on the application of the same, predefined amount of Lean Six Sigma-related change to each of the two or more process variables.

7. The system of claim 1, wherein each outcome is expressed as an improvement over a baseline value.

8. The system of claim 1, wherein the predefined amount of Lean Six Sigma-related change is expressed as a percentage improvement over a baseline value of each respective process variable.

9. The system of claim 1, wherein the operations further comprise:
using the outcomes to prioritize implementation of the Lean Six Sigma-related change for the two or more of the process variables.

10. The system of claim 1, wherein:
the provided information further comprises the metric, a target production rate, and an instruction to determine an outcome of independently applying a same, predefined percentage of Lean Six Sigma-related change to first through fourth process variables, and
the first process variable represents a set up duration, the second process variable represents an up-time duration, a third process variable represents an amount of scrap, and a fourth process variable represents a cleanup duration.

11. The system of claim 1, wherein the operations further comprise:
selecting, from among the two or more of the process variables, the process variables that exhibit non-linear outcomes based on the application of the same, predefined amount of Lean Six Sigma-related change to each of the two or more process variables.

12. The system of claim 11, further comprising:
facilitating training for the Lean practitioner candidate to implement Lean Six Sigma change on the selected process variables.

13. A computer storage medium encoded with a computer program, the program comprising instructions that when executed by data processing apparatus cause the data processing apparatus to perform operations comprising:
defining, for a workstation, a metric that is a function of multiple process variables;
providing, to a Lean practitioner candidate, information that suffices to allow the Lean practitioner candidate to determine outcomes of independently applying a same, pre-defined amount of Lean Six Sigma-related change to each of two or more of the process variables; and
obtaining information that specifies the outcomes from the Lean practitioner candidate.

14. A method comprising:
defining, for a workstation, a metric that is a function of multiple process variables;
providing, to a Lean practitioner candidate, by one or more computers, information that suffices to allow the Lean practitioner candidate to determine outcomes of independently applying a same, pre-defined amount of Lean Six Sigma-related change to each of two or more of the process variables; and
obtaining information that specifies the outcomes from the Lean practitioner candidate.

15. The method of claim 14, wherein the metric comprises a workstation turnover time metric that measures an amount of time that is required to set up and run one batch of product through the workstation.

16. The method of claim 14, further comprising:
determining, from the obtained information, that applying the predefined amount to a first process variable results in a linear outcome.

17. The method of claim 14, further comprising:
determining, from the obtained information, that applying the predefined amount to a first process variable results in a non-linear outcome.

18. The method of claim 14, wherein providing information that suffices to allow the Lean practitioner candidate to determine the outcomes of independently applying the same, predefined amount of Lean Six Sigma-related change to each of two or more of the process variables further comprises:
providing the metric to the Lean practitioner candidate; and
instructing the Lean practitioner candidate to:
determine, as a baseline outcome, a value for the metric using a first baseline value for a first process variable and a second baseline value for a second process variable,
determine an improved first process variable value based on applying the predefined amount of change to the first baseline value,
determine an improved second process variable value based on applying the predefined amount of change to the second baseline value,
determine, as a first possible outcome, a value for the metric using the improved first process variable value for the first process variable and the second baseline value for the second process variable; and
determine, as a second possible outcome, a value for the metric using the first baseline value for the first process variable and the improved second process variable value for the second process variable.

19. The method of claim 14, further comprising:
selecting, from among the two or more of the process variables, a process variable that exhibits a most improved outcome based on the application of the same, predefined amount of Lean Six Sigma-related change to each of the two or more process variables.

20. A system comprising:
one or more computers; and
a computer-readable medium coupled to the one or more computers having instructions stored thereon which, when executed by the one or more computers, cause the one or more computers to perform operations comprising:
receiving information from a project manager, the information specifying predefined amount of Lean Six Sigma-related change, and a metric for workstation, wherein the metric is a function of multiple process variables;
determining, using the information, outcomes of independently applying the same, predefined amount to each of two or more of the process variables; and
providing information that specifies the outcomes to the project manager.
